(19) United States
(12) Patent Application Publication
(10) Pub. No.: US 2023/0402722 A1
(43) Pub. Date: Dec. 14, 2023

(54) BATTERY CELL WITH A TABLESS ELECTRODE

(71) Applicant: TESLA, INC., Austin, TX (US)

(72) Inventors: Bonne Eggleston, Palo Alto, CA (US); Matthieu Moors, Sunnyvale, CA (US); Andrew Kalt, Oakland, CA (US); Matthew Grossman, Palo Alto, CA (US); Daniel MacNaughton, Oakland, CA (US); Douglas Schafer, San Diego, CA (US)

(21) Appl. No.: 18/044,763

(22) PCT Filed: Sep. 17, 2021
(86) PCT No.: PCT/US2021/050992

§ 371 Date: Mar. 9, 2023

Related U.S. Application Data
(60) Provisional application No. 63/167,565, filed on Mar. 29, 2021.
(60) Provisional application No. 63/081,244, filed on Sep. 21, 2020.

(51) Int. Cl. H01M 50/533; H01M 10/0587; H01M 50/534; H01M 50/538; H01M 50/152

(52) U.S. Cl. CPC H01M 50/533; H01M 10/0587; H01M 50/534; H01M 50/538; H01M 50/152; H01M 10/0525

(57) ABSTRACT

Energy storage devices and methods of manufacturing thereof, such as a lithium ion battery, without tabs connecting the electrode jellyroll to the can are described. A series of flags may be cut, bent and interleaved over one another to create a connection point for upper and lower collector plates within a can. The upper and lower collector plates may be welded directly to the interleaved flags to create connection points for the anode and the cathode within the energy storage device.

### INCORPORATION BY REFERENCE TO ANY PRIORITY APPLICATIONS

Any and all applications for which a foreign or domestic priority claim is identified in the Application Data Sheet or Request as filed with the present application are hereby incorporated by reference under 37 CFR 1.57, and Rules 4.18 and 20.6, such as U.S. Provisional App. No. 63/081,244, filed Sep. 21, 2020, and U.S. Provisional App. No. 63/167,565, filed Mar. 29, 2021.

### BACKGROUND

### Field

The present disclosure relates to energy storage devices and methods of making thereof. More specifically, the present disclosure relates to battery cells and methods of making battery cells having tabless cathodes and anodes.

### Description of the Related Art

Many types of battery cells are currently used as energy sources in electric vehicles and energy-storage applications. Many current cells use a jelly-roll design in which the cathode, anode, and separators are rolled together and have a cathode tab and an anode tab to connect to the positive and negative terminals of the cell can.

The path of the current necessarily travels through these tabs to connectors on the outside of the battery cell. However, ohmic resistance is increased with distance when current must travel all the way along the cathode or anode to the tab and out of the cell. Furthermore, because the tabs are additional components, add additional thickness to the device and must themselves be rolled into the jellyroll, they increase costs and present manufacturing challenges.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

One aspect is a method of making a battery cell comprising an anode or a cathode having a series of flags formed from the foil portions at the upper and lower ends of each electrode, wherein the flags are folded over at each end to form an interleaved flower shape.

In another aspect, a method of preparing a tabless energy storage device is described. The method includes providing an electrode layer having an active material disposed over a foil; forming a series of flags in the foil to form a flagged electrode; winding the flagged electrode to form an electrode roll comprising a series of rolled flags; and electrically connecting the rolled flags to a current collector to form an energy storage device.

In another aspect, a method of preparing a rolled electrode is described. The method includes providing an electrode layer comprising an active material disposed over a foil; forming a series of flags in the foil to form a flagged electrode; winding the flagged electrode to form an electrode roll comprising a series of rolled flags; and folding the rolled flags to form folded rolled flags, wherein each flag of the folded flags is directed into a substantially interleaved configuration.

In another aspect, a method of preparing a rolled electrode is described. The method includes providing an electrode layer comprising an active material disposed over a foil; forming a series of flags in the foil to form a flagged electrode; folding the flags to produce a folded flagged electrode comprising a series of folded flags; and winding the folded flagged electrode to form an electrode roll, wherein as the folded flags are wound each flag of the folded flags is directed into a substantially interleaved configuration.

In another aspect, an interleaved flagged electrode is described. The electrode includes a wound flagged electrode layer comprising an active material disposed over a foil; wherein the foil comprises a series of flags; and wherein each of the series of flags are folded and in a substantially interleaved configuration.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1A shows a perspective view of a battery cell can.

FIG. 1B shows a side view of a battery cell can.

FIG. 2 shows a perspective view of the material layers within the battery electrodes of one embodiment of the invention during a flag folding process.

FIG. 3A shows an image of battery electrodes with folded and interleaved flag features.

FIG. 3B shows an CT image of a cross-section of the battery electrodes of FIG. 3A showing upper interleaved and folded flags.

FIG. 3C shows a split image of the structure of battery electrodes with interleaved flag features where the left split image is a structural model of the flower design derived from forming a jellyroll using the interleaved flags, and the right split image is a density map model of the flags of the jellyroll.

FIG. 3D is a schematic diagram showing possible angles of electrode flags.

FIG. 4 shows a schematic of a cross section of a jellyroll of one embodiment of cathode and anodes having folded flags.

FIG. 5A shows embodiment of upper and lower current collectors, having cut-out portions.

FIG. 5B is an image of an upper current collector showing laser welds on cut-out portions.

FIG. 5C is a series of images of jellyrolls having upper and lower current collectors, along with different patterns of laser welds.

FIG. 6A shows an electrode roll having a cap or top used to compress and fold flags at the end of the roll into an interleaved position.

FIG. 6B shows images of tops that can be used to compress flags as shown in FIG. 6A.

FIG. 7A shown a perspective view of a directed air ring and press for interleaving electrode flags.

FIG. 7B is a cross-sectional cut-away view of the directed air ring from FIG. 7A showing the internal air channels and outlets.

FIG. 8 shows a perspective view of a diverter and set of rollers for folding electrode foil flags prior to winding.

FIG. 9 shows a perspective view of a roller and wedge configuration for folding electrode foil flags prior to winding.

FIG. 10 shows a perspective view of a press roller and anvil configuration for folding electrode foil flags prior to winding.

FIG. 11A is a diagram illustrating the problem of flags interfering with one another as an electrode is being wound into a roll.

FIG. 11B is a diagram illustrating a flag management system being used to nudge or move the flags into an interleaved position with respect to one another so the trailing edge of one flag lies underneath the forward edge of the adjacent flag as the roll is being wound.

FIG. 12 is a schematic illustration of an inspection device that may be used to inspect an electrode roll.

FIG. 13A is a set of images showing the process of inspecting flag formation in a wound electrode roll.

FIGS. 13B, 13C and 13D are images taken of mis-formed electrode rolls as they are being inspected.

### DETAILED DESCRIPTION

The present disclosure relates to energy storage device cells and methods of making cells for energy storage devices, such as a lithium ion battery having a tabless connection from the anode conductor and the cathode conductor to the can. In one example, within a jellyroll cell design, the negative electrode and the positive electrode are made to include flag structures at their edges for making an electrical connection to the battery can. When each flagged electrode is wound within a jellyroll configuration, the flags may be pressed inward forming an interleaved “flower” or “artichoke” shaped configuration at each end of the jellyroll. The folded flags may be joined (e.g. pressed, soldered, laser welded, etc. . . . ) to top and bottom current collectors at the ends of the battery cell to form a cylindrical unit. The cylindrical unit may then be loaded into a battery can for final processing to form a lithium ion battery.

Each electrode may have dozens or hundreds of flags and the flags can be of any configuration. For example, the flags may be spaced very close together to form a flower shape when wound within the jellyroll. In other embodiments, the flags may be spaced so that each flag aligns with other flags to form a single line of flags on one side of the jellyroll. In one embodiment, the flags are spaced so that they become interleaved as the jellyroll is formed. In one embodiment, the interleaved flags are able to be compressed to a flat, or substantially flat configuration at each end of the cell.

In one embodiment, each end of the cell is capped with a current collector. The current collector may be a solid circular metallic structure. In other embodiments, it may have cut-outs formed which act to release axial or torsional stress from the components within the jellyroll. For example, a set of triangular, circular, square, rectangular, or other geometric forms can be cut out from the current collectors to give the current collector more ability to bend with stresses placed on the battery cells.

Reference will now be made in detail to specific aspects or features, examples of which are illustrated in the accompanying drawings. Wherever possible, corresponding or similar reference numbers will be used throughout the drawings to refer to the same or corresponding parts.

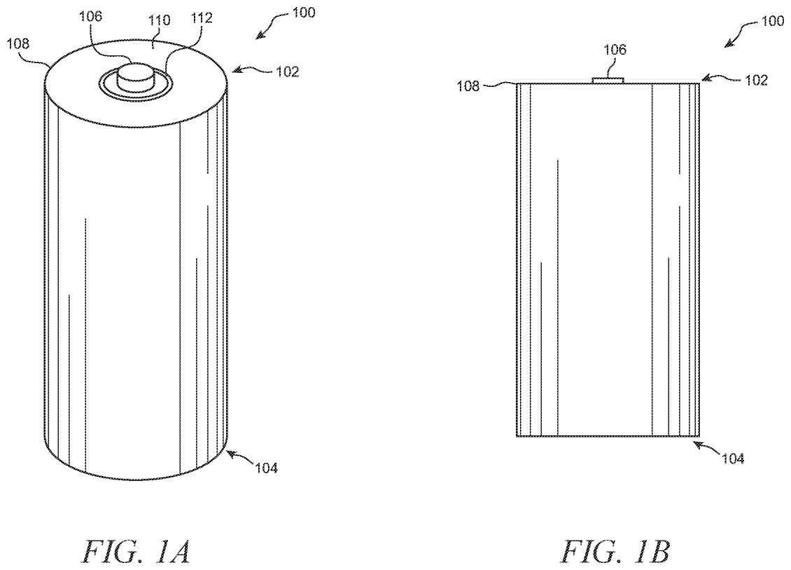

FIG. 1 illustrates a battery cell 100 in a perspective view through FIG. 1A, and in a side view through FIG. 1B. With combined reference to FIGS. 1A and 1B, the battery cell 100 may be any type of a conventional battery cell which may convert chemical energy of substances stored in the battery cell 100 into electrical energy. The battery cell 100 has a first end 102 and a second end 104. The battery cell 100 has a positive terminal 106 and a negative terminal 108 towards the first end 102. The positive terminal 106 preferentially protrudes from the first end 102 the battery cell 100 to allow a contact to be made to the positive terminal 106 and differentiate the first end 102 from the second end 104, although different geometries of the positive terminal 106 may exist. The negative terminal 108 preferentially begins on the second end 104 and continues on the outer surface 110 of the battery cell 100 and wraps at least to a portion of first end 102. The portion of the battery cell 100 that wraps from the outer surface to the first end may be referred to as the “shoulder” of the battery cell 100. The negative terminal 108 preferentially is formed on the shoulder, so that connections to the negative terminal may be made on the shoulder. In other words, the negative terminal 108 preferentially exists on shoulder of the battery cell 100. An insulation region 112 may be provided on the surface 110 of the battery cell 100 such that the positive terminal 106 and the negative terminal 108 do not short due to mutual contact. The insulating region 112 may be provided through any other means as well on area of the surface 110 between the positive terminal 106 and the negative terminal 108. In alternate embodiments, the positive and negative terminals could be switched.

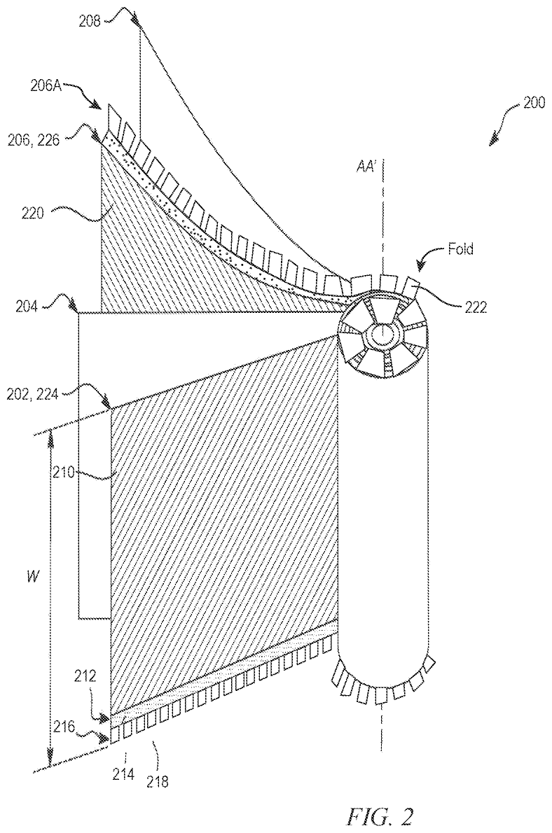

As shown in FIG. 2, a jellyroll 200 includes a first substrate 202 having a first coating 210 disposed on a side of the first substrate 202. In some embodiments, the first coating 210 may be disposed on both sides of the first substrate 202 to form a double layered electrode. In some embodiments, the first substrate 202 is embodied, preferably, in the form of a laminate that has a pre-determined amount of thickness, for example, in the range of 0.01-1 millimeter (mm). In some embodiments, the first substrate 202 comprises a current collector. In some embodiments, the current collector comprises a metallic foil. In some embodiments, the current collector comprises aluminum or copper.

In some embodiments, the first coating 210 may be an electrically conductive coating having a first amount of electrical conductivity. In some embodiments, the first coating 210 may be an electrode film. In some embodiments, the electrically conductive coating comprises an electrode active material. In some embodiments, the electrode active material is a cathode active material. In some embodiments, the electrode active material is an anode active material. In some embodiments, the electrode active material is selected from a silicon material (e.g. metallic silicon and silicon dioxide), graphitic materials, graphite, graphene-containing materials, hard carbon, soft carbon, carbon nanotubes, porous carbon, conductive carbon, lithium nickel manganese cobalt oxide (NMC), a lithium manganese oxide (LMO), a lithium iron phosphate (LFP), a lithium cobalt oxide (LCO), a lithium titanate (LTO), a lithium nickel cobalt aluminum oxide (NCA), a layered transition metal oxide (such as LiCoO₂ (LCO), Li(NiMnCo)O₂ (NMC) and/or LiNi_{0.8}Co_{0.15}Al_{0.05}O₂ (NCA)), a spinel manganese oxide (such as LiMn₂O₄ (LMO) and/or LiMn_{1.5}Ni_{0.5}O₄ (LMNO)), an olivine (such as LiFePO₄), chalcogenides (LiTiS₂), tavorite (LiFeSO₄F), silicon, silicon oxide (SiOx), aluminum, tin, tin oxide (SnOx), manganese oxide (MnOx), molybdenum oxide (MoO₂), molybdenum disulfide (MoS₂), nickel oxide (NiOx), copper oxide (CuOx), and lithium sulfide (Li₂S), or combinations thereof.

In some embodiments, the first coating further comprises a binder. In some embodiments, the first coating 210 may be disposed on the first substrate 202 by any means known to persons skilled in the art. Some examples of disposing the first coating 210 onto the first substrate 202 include, but are not limited to, mechanical deposition, electromechanical deposition, electrochemical deposition, or any combination of processes known to persons skilled in the art.

Additionally, or optionally, a foil portion 212 of the first substrate 202, located partway along a width W of the first substrate 202, is formed which includes a series of lower flags 218. As shown, then the jellyroll is formed, the lower flags 218 become wound around the central axis AA′. In some embodiments, the lower flags 218 are an exposed region of the first substrate 202 (e.g. current collector). In some embodiments, the conductive portion 218 consists or consists essentially of the first substrate 202.

An inner separator 204 is disposed over (e.g. stacked on top of) the first substrate 102. In some embodiments, the inner separator 204 is in the form of a laminate that has a pre-determined amount of thickness, for example, in the range of 0.01-0.05 millimeters (mm). In some embodiments to inner separator is or is about 10 μm, 15 μm, 20 μm, 30 μm, 40 μm or 50 μm, or any range of values therebetween (e.g. 10-15 μm). Furthermore, in some embodiments the inner separator 204 is electrically insulative. In some embodiments, the inner separator may comprise a polymeric material. In some embodiments, the inner separator may be selected from polyethylene, polypropylene, or combinations thereof. In some embodiments, the inner separator comprises multiple separator layers. In some embodiments, the inner separator comprises micro-pores.

Further, a second substrate 206 is disposed over (e.g. stacked on top of) the inner separator 204. The second substrate 206 has a second coating 220 disposed on a side of the second substrate 206. In some embodiments, the second coating 220 may be disposed on both sides of the second substrate 206. In some embodiments, the second substrate 206 is in the form of a laminate that has a pre-determined amount of thickness, for example, in the range of 0.01-1 millimeter (mm). In some embodiments, the second substrate 206 comprises a current collector (e.g. a foil).

The second coating 220 is an electrically conductive coating having a second amount of electrical conductivity. In some embodiments, the second coating 220 may be an electrode film. In some embodiments, the electrically conductive coating comprises a electrode active material. In some embodiments, the electrode active material is a cathode active material. In some embodiments, the electrode active material is an anode active material. In certain embodiments, the second coating 220 may be similar to or the same as the first coating 210 and therefore may have similar or the same electrical conductivity. In certain other embodiments, the second coating 220 may be different than the first coating 210 and therefore may have different electrical conductivities. In some embodiments, the second coating 220 may be disposed on the second substrate 206 by any means known to persons skilled in the art. Some examples of disposing the second coating 220 onto the second substrate 206 include, but are not limited to, mechanical deposition, electromechanical deposition, electrochemical deposition, or any combination of processes known to persons skilled in the art.

An outer separator 208 may be disposed over (e.g. stacked on top of) the second substrate 206. In some embodiments, the outer separator 208 is in the form of a laminate that has a pre-determined amount of thickness, for example, in the range of 0.01-0.05 millimeters (mm). Furthermore, the outer separator 208 is electrically insulative. Upon stacking the first substrate 202, the inner separator 204, the second substrate 206, and the outer separator 208 in a successive manner, the first substrate 202, the inner separator 204, the second substrate 206, and the outer separator 208 are rolled about a central axis AN with the first substrate 202 being closest in position to the central axis AA′.

As shown, the second substrate 206 includes a series of flags 206A which are formed from the foil in communication with the second substrate 206. These flags 206A become wound around the upper layer of the jellyroll to form a flower or artichoke shape if bent over towards the central axis AA′ as the jellyroll is being created.

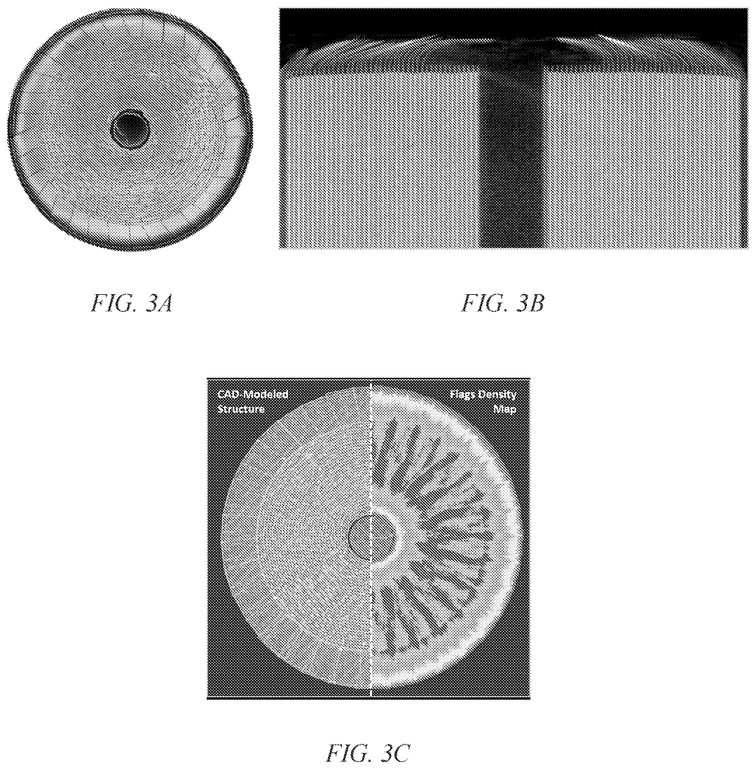

FIG. 3A is a photograph that shows one embodiment of an anode having upper flags that are folded over to create the flower structure. FIG. 3B is a CT scan of a cross-section of the device of FIG. 3A and shows that the folded flags are in electrical communication with one another, but not with any portion of the cathode material shown in the lower portion of FIG. 3B.

FIG. 3C shows a split image of the structure of battery electrodes with flag features where the left slip image is a structural model of the flower design derived from forming a jellyroll using the flags, and the right split image is a density map model of the flags of the jellyroll. As shown, in this embodiment, the flags are relatively square in shape. Of course, it should be realized that any related geometric shape, such as rectangle, triangles, and trapezoid shaped flags may be used similarly to form the flag structures from the anode or cathode.

FIG. 3D is a diagram showing that the flags may be angled in one direction. In one embodiment, the flags are angled toward the direction of the jellyroll. In another embodiment, the flags are angled away from the direction of the jellyroll. The flags may be angled from zero to 30 degrees or more in one embodiment, including being angled from 5-10 degrees, from 11-20 degrees, from 21-30 degrees, from 10-15 degrees, or any number in between, such as including about 10, 10.5, 11, 11.5, 12, 12.5, 13 13.5, 14, 14.5, or 15 degrees. Each flag may be between 1-10 mm in height and from 1-10 mm in width. For example, the flags may be from 3-6 mm in height and from 3-6 mm in width.

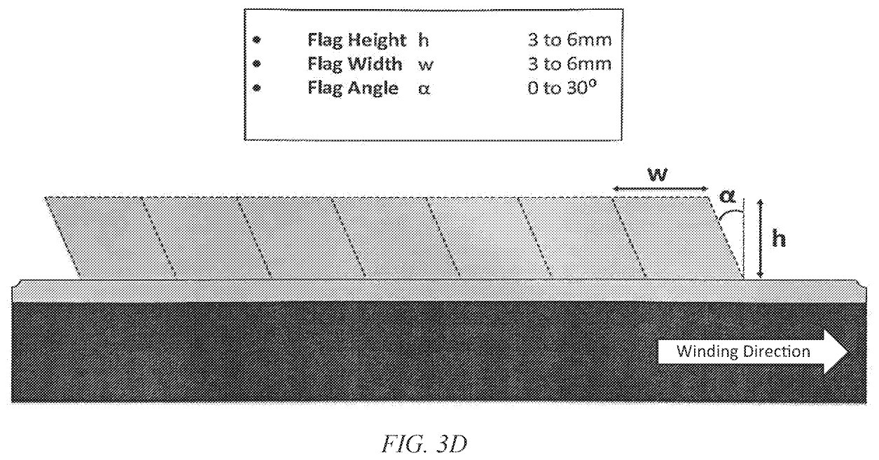

FIG. 4 is a side cross-sectional view of one embodiment of a jellyroll. This configuration includes anode 405 connecting to a copper flag 408. Insulators 410A and 410B prevent the anode material from contacting an adjacent cathode 415. The cathode 418 is electrically connected to an aluminum flag 418. As can be seen upon review of FIG. 4, each anode section within the jellyroll is connected to an upper copper flag and each cathode section within the jellyroll is connected to a lower aluminum flag.

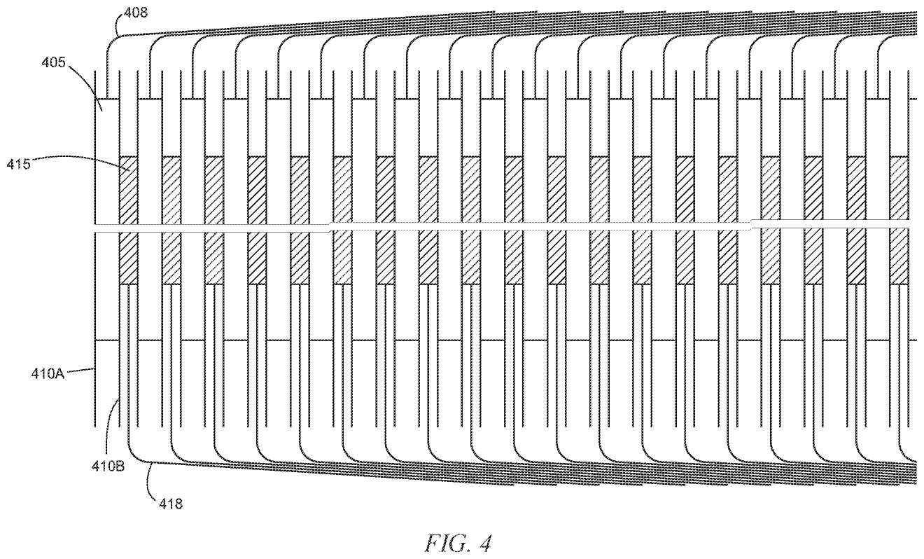

FIG. 5A shows an aluminum current collector 500 that would connect to the aluminum flags from the cathode. As can be envisioned upon review of FIG. 3A, the current collector is placed over the top of the flower structure formed by the interleaved flags. That current collector compresses the flag and can make an electrical connection throughout a large surface area of the flower structure formed from the flags. As shown, each current collector 500 includes a series of cutout sections 510A, 510B which act to release strain from any torsional movement by the electrodes within the cylinder. FIG. 5A also shows a copper current collector 525 having cutouts 530A, 530B which connect to the anode.

FIGS. 5B and 5C show that copper and aluminum current collectors that have been laser welded from the top which weld the current collectors to the flags formed at the top and bottom of each cylindrical unit. It should be realized that while the laser weld is showing as a circle in the figures, it is not limited to that particular shape. Laser welds of lines, curves, circles and other geometric shapes are all contemplated within the scope of the invention. In some embodiments, the flags may be connected to the current collectors by press contact, solder joint, welding (e.g. laser welding), and combinations thereof.

### Method of Manufacture

The tabless energy storage device may be manufactured in a high-speed and/or high-volume process suitable for commercial manufacturing. Embodiments of methods of making device may include starting with an electrode comprising a lithium ion current collector and a foil portion located at an end of a width of the electrode.

With the provided electrode, a series of flags is formed from the foil portion of each electrode to produce a flagged electrode. In some embodiments, the flags are produced by forming slits on the foil portion of the positive and negative electrodes as discussed above. In some embodiments, the slits are formed by cutting or laser etching the foil. In some embodiments, the series of flags are formed into a pattern such that when the electrode is wound the flags are configured to form the “flower” or “artichoke” shaped configuration. The flags may be interleaved, with a trailing edge of one flag being folded under the leading edge of an adjacent flag.

The flagged electrode is wound into a “jellyroll” to form an electrode roll comprising a rolled series of flags. In some embodiments, the rolled series of flags are substantially straight (i.e. unfolded) such that each of the flags do not substantially overlap with the others in the electrode role. In some embodiments, the rolled series of flags are folded towards the interior of the electrode roll.

To form the “flower” or “artichoke” shaped configuration of the flags of the electrode roll, the flags are folded towards the center line (i.e. center axis) of the electrode roll. In some embodiments, the series of flags are folded post-winding. In some embodiments, the jellyroll is first wound, and then post-winding the flags are folded towards the centerline of the jellyroll. In some embodiments, the flags are folded sequentially, or successively from the outer portion of the flags toward the inner portion of the flags. In some embodiments, successive folding is performed on each or a grouping of the flags. In some embodiments, successive folding is performed by a roller as the jellyroll is turned so that the roller presses against the outermost flags first, and then successively moves inward, interleaving each circumferential set of flags underneath each other.

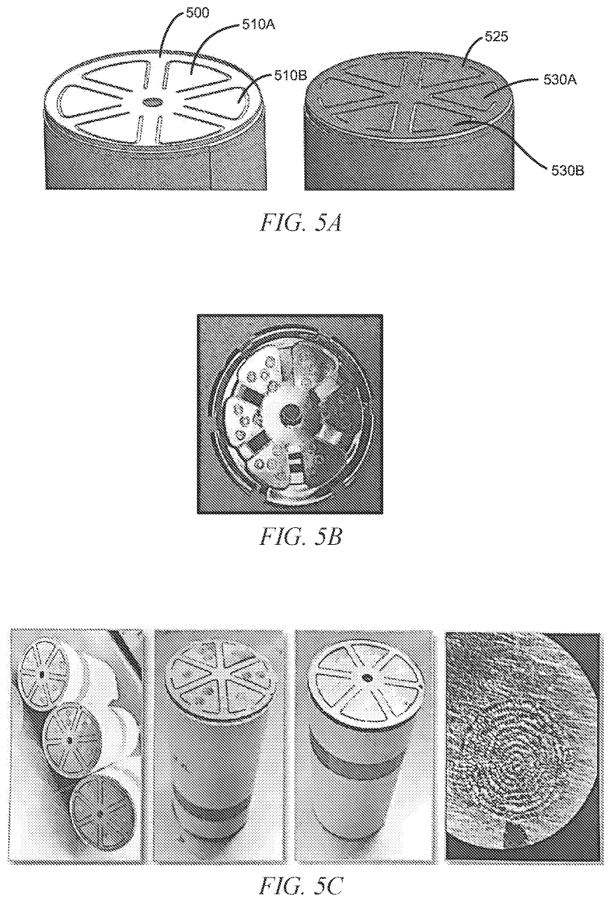

In some embodiments, the post-winding folding of the flags is performed concurrently on all or substantially all of the flags. For example, as shown in FIG. 6A, a press or cap (FIG. 6B) may be placed over the top of the set of flags at each end of the jellyroll to bend the flags toward the centerline of the jellyroll. In some embodiments, concurrent folding is performed by a press. In some embodiments, the press is selected from a flat shaped press, a dome shaped press, and combinations thereof. In some embodiments, the jellyroll or the cap or press is rotated to help fold, press down and interleave the flags towards the centerline to form the structure shown in FIGS. 3A-3C.

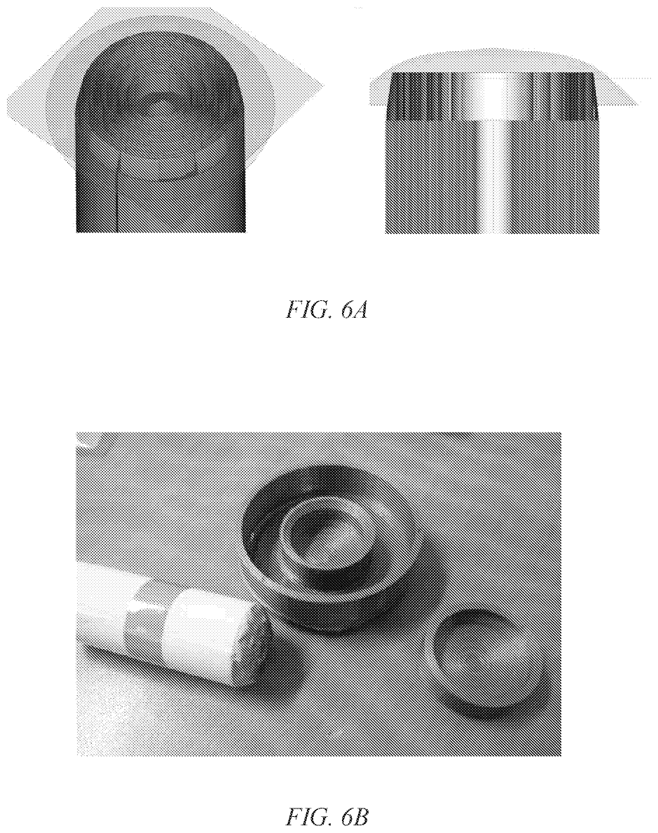

In some embodiments, a directed air ring or “blow ring” as shown in FIGS. 7A and 7B, comprises a ring-shaped device that can accommodate the end of the jellyroll. Holes within the center circumference of the ring are positioned or configured to output compressed air at an angle to form a vortex of air at the center of the ring. The vortex of air may be used to press down and interleave the flags into their final position at the end of the jellyroll. As illustrated in FIG. 7A a press with a stalk and circular bottom portion may be used after the flags are interleaved into their proper position to bend and press the flags down to their final position in the flower shaped arrangement. In some embodiments, a press and a directed air ring may be used simultaneously to fold and/or substantially interleave the flags.

As can be envisioned upon review of FIGS. 7A and 7B, the end of a jellyroll having flags is inserted into the center of the directed air ring and compressed air is forced at an angle through the central holes. The air forms a swirling vortex which help angle, interleave and press the flags into the final flower shape by pressing each flag gently into position using the air pressure. In some embodiments, the directed air ring is configured to produce a fluidized bed for the flags. It should be realized that the directed air ring isn't limited to embodiments with center holes or orifices which create the pressurized vortex of air. In other embodiments, the central portion may include slits, channels, or other outlets for the pressurized air which create a pressurized airspace which is useful for interleaving the flags into their final form in the jellyroll.

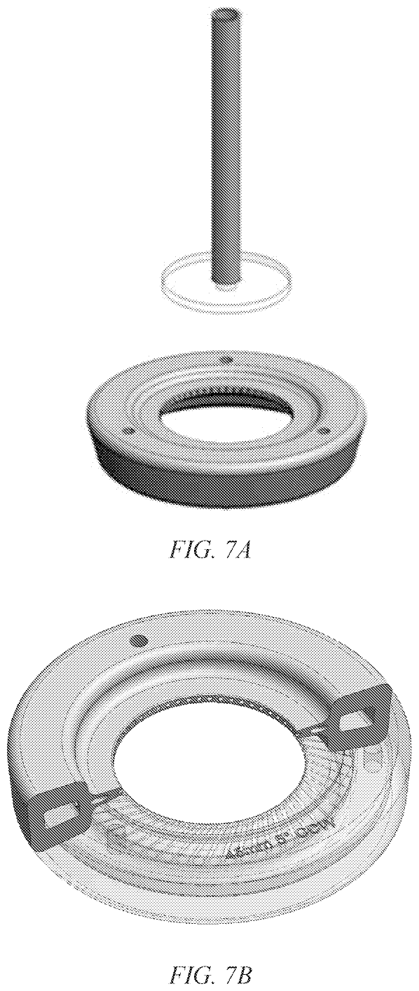

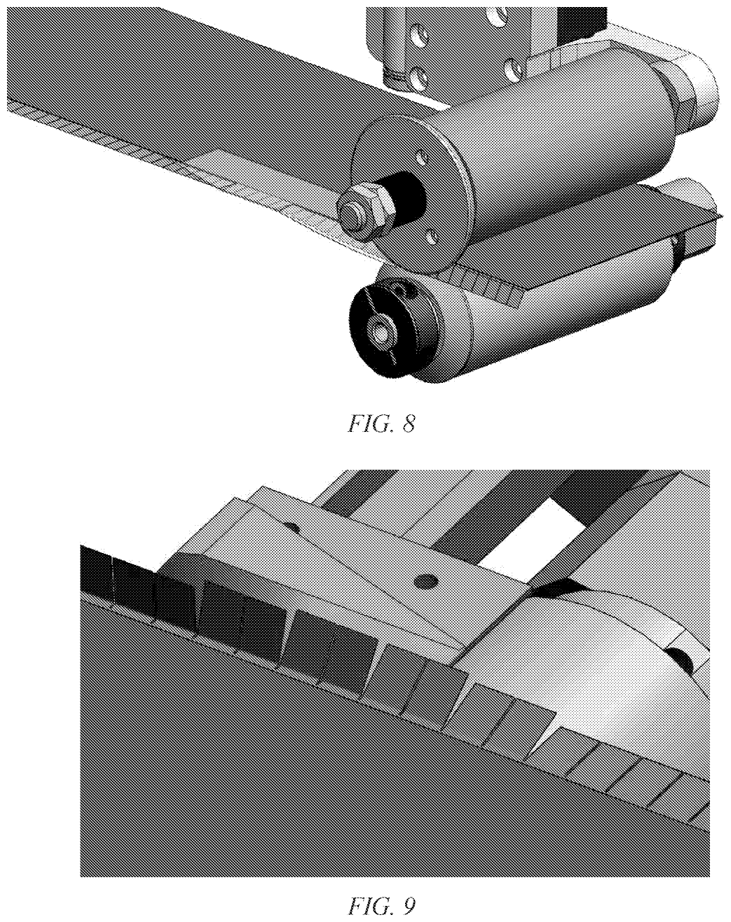

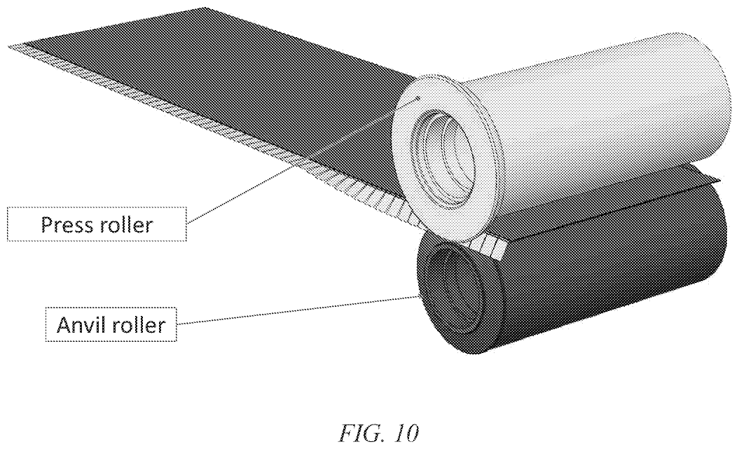

In some embodiments, prior to winding the jellyroll, the flags of the electrode are pre-folded inline (i.e. pre-winding). As shown in FIG. 8, in some embodiments, inline folding is performed by a deflector which bends the flags in one direction as they approach a roller. The roller may complete the bend so that flags have a permanent fold, crease or bend to them with respect to the foil portion of the electrode. In an embodiment shown in FIG. 9, the flags are bent by moving across a roller and then contacting a wedge which pushes the flags upward into a bent position with respect to the foil electrode. In some embodiments, inline folding using a deflector also includes a mating surface to the deflector that forms a narrow channel through which the flags pass through to form the bend. Of course, there are myriad ways to fold the flags, and these are just some examples of ways in which the flags can be folded prior to formation of the jellyroll. In another example shown in FIG. 10 a press roller is position adjacent to an anvil roller and the foil with flags are run between them. The press roller bends the flags against the anvil roller as the flag pass through the roller set. It should be realized that other embodiments, including two or more rollers, a scoring spool, or combinations thereof are also contemplated.

In some embodiments, the folding roller is a pinch roller, a press roller, or combinations thereof. In some embodiments, the roller is configured to allow the flags to overhang over an edge of the roller. In some embodiments, the flags of the electrode are folded inline and further folded post-winding of the electrode to obtain their final interleaved flower shape.

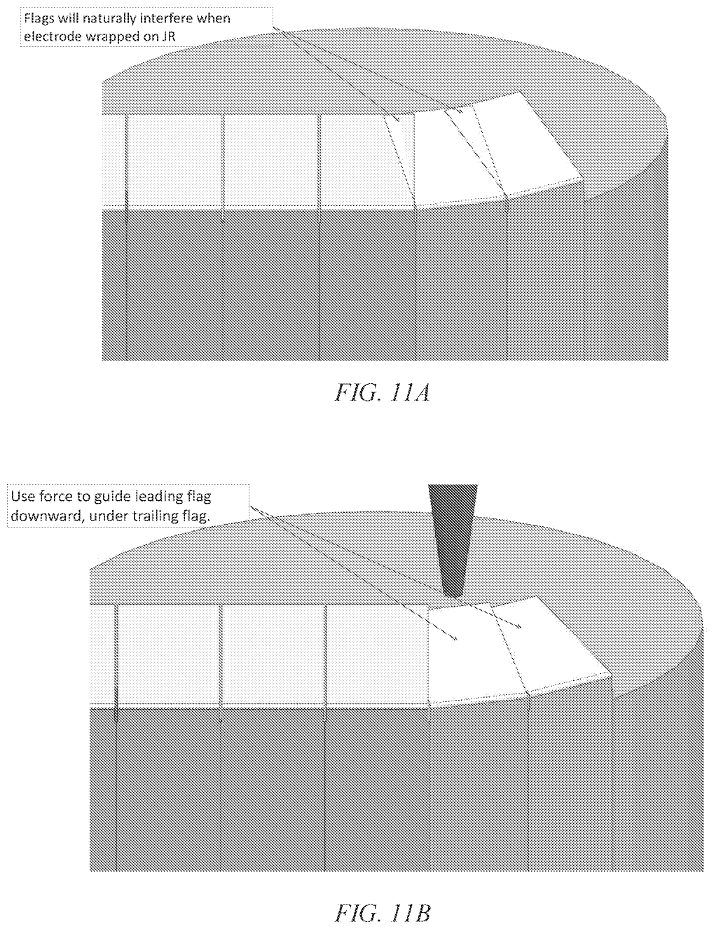

As shown in FIG. 11A, during the winding process, the flags may interfere with each other and become tented and/or clumped over each other such that a regular interleaved pattern of flags is not formed. As such, in some embodiments the flag positions of the unwound electrode sheet and/or wound electrode role may be managed or treated by a flag management device as show in FIG. 11B in order to form a substantially interleaved flag pattern in the final electrode roll. In some embodiments, flag management device includes a mechanical deflector, an angled roller, directed air device (e.g. pressurized air nozzle), or combinations thereof. For example, as the lateral electrode is being wound into the jellyroll, the flag management device may move, nudge, blow, or press the flags towards their correct interleaved position within the jellyroll without tenting or clumping of the flags at each end of the electrode.

In some embodiments, after the jellyroll is wound with folded flags, a second step is taken to finalize the flags into their interleaved position. In some embodiments the second step utilizes a flag treatment device. This post-winding flag treatment may be performed by a mechanical deflector, a roller, a press, a directed air device (e.g. a directed air ring or an air jet), or combinations thereof. In some embodiments, the roller is a successive roller. In some embodiments, the press is selected from a flat shaped press, a dome shaped press, and combinations thereof.

Subsequent to the formation of the electrode roll, any remaining portions of the electrode sheet that are not used to form the electrode roll may be removed by cutting. In some embodiments, cutting is performed by blade cutting, scissor cutting, laser cutting, or combinations thereof. Subsequent to cutting away the first electrode roll from the remaining electrode sheet, a second electrode roll may be formed from the remaining electrode sheet.

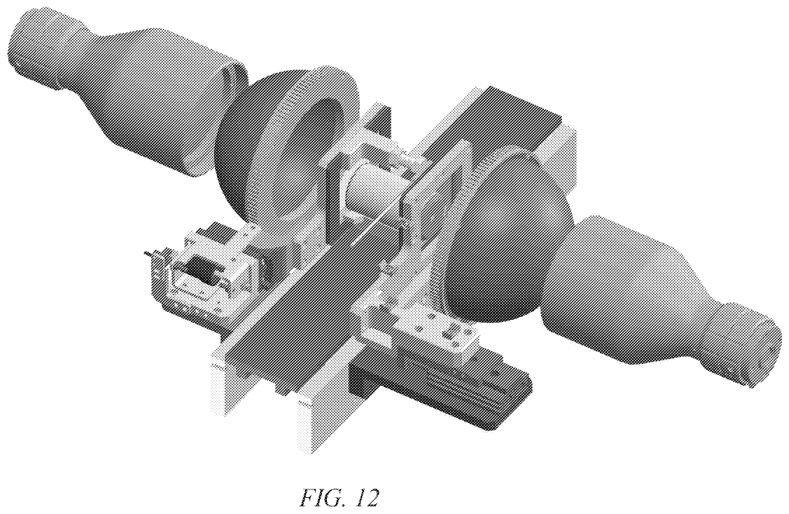

The electrode rolls may be inspected to confirm that the electrode roll meets manufacturing parameters, such as electrode roll height and/or that the flags at each end of the roll are properly interleaved without tenting or clumping. In some embodiments, the folded flags are pressed against a transparent glass or plastic window, and an image is taken through the window of the pressed folded flags. FIG. 12 shows a schematic of an inspection device that may be used to inspect the electrode roll, wherein the inspection device includes two glass plates and two image capture devices positioned on the outer faces of the glass plates, and a press system comprising the press assembly, and a hardstop assembly configured to press the ends of an electrode roll using the two glass plates. In FIG. 12 an electrode roll is shown pressed between the two glass plates such that the image capture devices may capture images of the pressed flags of the anode and cathode of the electrode roll through the glass plates. The inspection device of FIG. 12 also includes a jellyroll (JR) height measurement assembly used to measure the height of the electrode roll as measured by the distance between the glass plates when pressed.

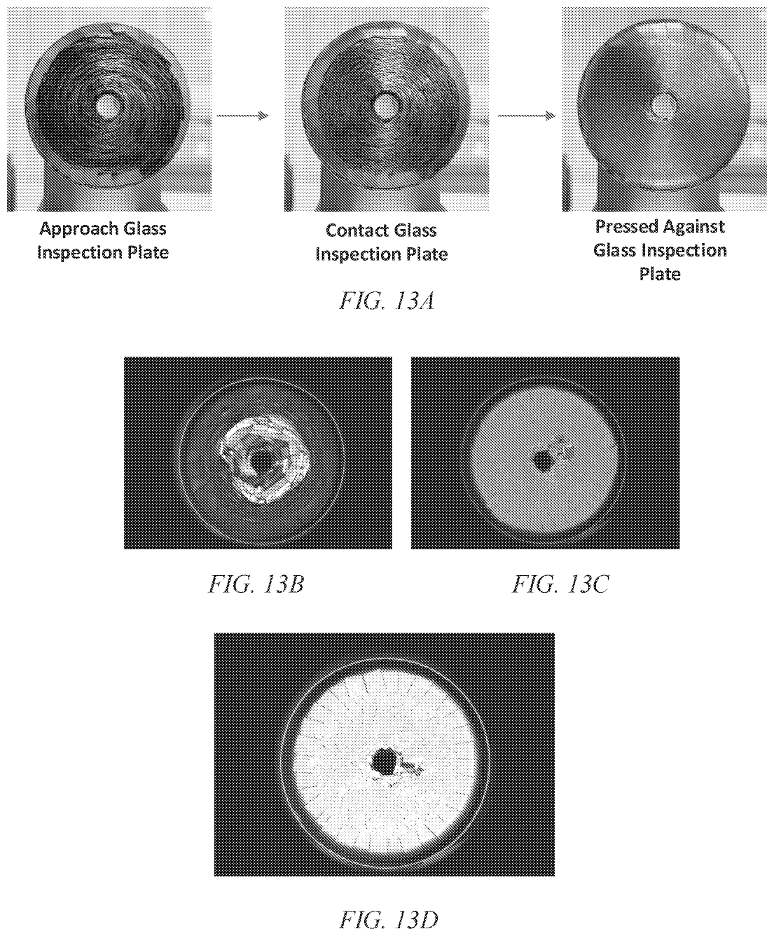

FIG. 13A shows a three-step process where one end of a jellyroll is inspected by pressing the end against a glass plate, for example such as using the inspection device of FIG. 12. As shown, a robotic arm or press is used to push the end of the roll towards the glass inspection plate. The end first approaches the glass plate with the flags partially bent from the prior folding processes during manufacture. The end continues to press against the glass plate as the flags become more compressed and interleaved. Finally, the end is pressed fully against the glass inspection plate so that the entire end flower structure is available to be imaged by an image capture and processing system.

It should be realized that the electrode roll has a flag formation at each end of the roll, with one end having the cathode flags and the other end having the anode flags. In some embodiments, during inspection the roll may be simultaneously pressed against two glass plates and both ends. In some embodiments, during inspection the roll may be inspected at one end and then rotated to have the other end inspected. In some embodiments, during inspection the roll may be inspected at one end and then translated to another inspection station to have the other end inspected.

An image processor is fed the image of the fully compressed end of the roll and may be used to identify damaged, tented and/or clumped flags. The image processor may look for dark spots signifying a clump or damaged set of flags. FIGS. 13B, 13C and 13D show examples of poorly folded rolls, with bend or misshapen flags creating identifiable dark spots on the image. The image processor may look for flags bent outside the circumference of the jellyroll. The image processor may also look for other indications that the flags did not smoothly interleave with one another, such as difference in light reflectance and different wavelengths to determine if any winding errors were made. In one embodiment, the image processer may have machine learning capabilities to analyze properly folded and wound electrodes and be trained to use deep learning to develop weights and biases which help it learn over time how to identify misfolded or damaged flags within the jellyroll. If a particular electrode does not pass inspection an alarm, signal, or light may be activated to indicate that the electrode did not pass inspection.

Once the electrode roll is formed it may be used to form an electrode storage device, such as a battery or wrapped for storage and later use to form a battery. In some embodiments, the folded flags of the electrode role are electrically connected to a current collector. In some embodiments, the flags may be connected to the current collectors by press contact, solder joint, welding, and combinations thereof. In some embodiments, welding is performed by laser welding. In some embodiments, the electrode role is placed into a housing and the housing is sealed. In some embodiments, electrolyte is added to the housing.

The rolled electrode manufacturing process is performed at high speeds and/or high volumes. In some embodiments, the electrode rolling or winding process is performed at a speed of, of about, of at least, or of at least about, 0.5 m/s, 0.6 m/s, 0.7 m/s, 0.8 m/s, 0.9 m/s, 1 m/s, 1.2 m/s, 1.4 m/s, 1.6 m/s, 1.8 m/s, 2 m/s, 2.2 m/s, 2.4 m/s, 2.6 m/s, 2.8 m/s, 3 m/s, 3.5 m/s, 4 m/s, 5 m/s, or any range of values therebetween. For example, in some embodiments the electrode rolling process is performed at a speed of, or of about, 1-3 m/s. In some embodiments, the high speeds of the manufacturing process accurately produce rolled electrodes with substantially interleaved flags.

In one example process, an electrode with a foil is provided and slits are formed on the foil to produce flags. The electrode is wound into jellyroll electrode, and the remaining electrode film is cut away from the rolled electrode. The straight flags of the cut rolled electrode are folded, and the flag position is managed. Subsequently, the rolled electrode is inspected for flag defects.

In another example process, an electrode with a foil is provided and slits are formed on the foil to produce flags. The flags are folded inline, immediately prior to winding the flag position is managed, and subsequently the electrode is wound into jellyroll electrode. The remaining electrode film is cut away from the rolled electrode and inspected for flag defects.

After the roll has been manufactured with interleaved flags it has anode and cathode current collectors welded, bonded, or otherwise electrically connected at each end as discussed above with reference to FIGS. 5A-5C to form a cartridge that may be placed into a can with electrolyte to form a lithium ion battery. In some embodiments, the interleaved flags are electrically connected directly to each end of the can.

The foregoing disclosure is not intended to limit the present disclosure to the precise forms or embodiments disclosed herein. As such, it is contemplated that various alternative forms, embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed battery system. It is to be understood that the forms of disclosure herein shown and described are to be taken as representative embodiments. Equivalent elements, or materials may be substituted for those representatively illustrated and described herein. Moreover, certain features of the disclosure may be utilized independently of the use of other features, all of which is apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., connected, associated, coupled, and the like) are only used to aid the reader's understanding of the present disclosure, and may not create limitations, particularly as to the position, orientation, or use of the elements disclosed herein. Therefore, joinder references, if any, are to be construed broadly. Moreover, such joinder references may not necessarily infer that two elements are directly connected to each other.

Additionally, all numerical terms, such as, but not limited to, “first”, “second”, “one”, “another”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed in certain cases, as is useful in accordance with a particular application.

What is claimed is:

1. A method of preparing a tabless energy storage device, comprising:
providing an electrode layer having an active material disposed over a foil;
forming a series of flags in the foil to form a flagged electrode;
winding the flagged electrode to form an electrode roll comprising a series of rolled flags; and
electrically connecting the rolled flags to a current collector to form an energy storage device.

2. The method of claim 1, wherein prior to winding the flagged electrode the flags are folded to become a series of folded flags.

3. The method of claim 2, wherein folding is performed by a deflector, a roller, a scoring spool, or combinations thereof.

4. The method of claim 2, wherein as the folded flags are wound a flag management device moves the folded flags into a substantially interleaved configuration.

5. The method of claim 4, wherein the flag management device comprises a diverter, a wheel, or an air nozzle.

6. The method of claim 1, wherein subsequent to winding the flagged electrode the flags are folded to become a series of folded flags.

7. The method of claim 6, wherein folding is performed successively.

8. The method of claim 7, wherein folding is performed by a roller, a directed air device, and combinations thereof.

9. The method of claim 6, wherein folding is performed concurrently.

10. The method of claim 9, wherein folding is performed by a press, a directed air device, and combinations thereof.

11. The method of claim 6, wherein the folded flags are in a substantially interleaved configuration.

12. The method of claim 6, wherein a flag treatment device moves the folded flags into a substantially interleaved configuration.

13. The method of claim 12, wherein the flag treatment device comprises a mechanical deflector, a roller, a press, a directed air device, or combinations thereof.

14. The method of claim 1, the electrode layer comprises a first section used to form the electrode roll and a second section, wherein the method further comprises cutting the first and second sections apart.

15. The method of claim 1, further comprising inspecting the rolled flags of the electrode roll.

16. The method of claim 1, wherein the electrode winding process is performed at a speed of about 1-3 m/s.

17. A method of preparing a rolled electrode, comprising:
providing an electrode layer comprising an active material disposed over a foil;
forming a series of flags in the foil to form a flagged electrode;
winding the flagged electrode to form an electrode roll comprising a series of rolled flags; and
folding the rolled flags to form folded rolled flags, wherein each flag of the folded flags is directed into a substantially interleaved configuration.

18. A method of preparing a rolled electrode, comprising:
providing an electrode layer comprising an active material disposed over a foil;
forming a series of flags in the foil to form a flagged electrode;
folding the flags to produce a folded flagged electrode comprising a series of folded flags; and
winding the folded flagged electrode to form an electrode roll, wherein as the folded flags are wound each flag of the folded flags is directed into a substantially interleaved configuration.

19. An interleaved flagged electrode, comprising:
a wound flagged electrode layer comprising an active material disposed over a foil;
wherein the foil comprises a series of flags; and
wherein each of the series of flags are folded and in a substantially interleaved configuration.

20. The electrode of claim 19, wherein the active material is selected from the group consisting of: silicon materials, graphitic materials, graphite, graphene-containing materials, hard carbon, soft carbon, carbon nanotubes, porous carbon, conductive carbon, lithium nickel manganese cobalt oxide (NMC), a lithium manganese oxide (LMO), a lithium iron phosphate (LFP), a lithium cobalt oxide (LCO), a lithium titanate (LTO), a lithium nickel cobalt aluminum oxide (NCA), a layered transition metal oxide (such as LiCoO₂ (LCO), Li(NiMnCo)O₂ (NMC) and/or LiNi_{0.8}Co_{0.15}Al_{0.05}O₂ (NCA)), a spinel manganese oxide (such as LiMn₂O₄ (LMO) and/or LiMn_{1.5}Ni_{0.5}O₄ (LMNO)), an olivine (such as LiFePO₄), chalcogenides (LiTiS₂), tavorite (LiFeSO₄F), silicon, silicon oxide (SiOx), aluminum, tin, tin oxide (SnOx), manganese oxide (MnOx), molybdenum oxide (MoO₂), molybdenum disulfide (MoS₂), nickel oxide (NiOx), copper oxide (CuOx), and lithium sulfide (Li₂S), and combinations thereof.

21. The electrode of claim 19, wherein the flags are square or trapezoidal in shape.

22. The electrode of claim 19, wherein the flags are angled from 5-10 degrees, from 11-20 degrees, from 21-30 degrees, or from 10-15 degrees.

23. The electrode of claim 19, wherein each flag of the flags is from 1-10 mm in height.

24. The electrode of claim 19, wherein each flag of the flags is from 1-10 mm in width.

25. The electrode of claim 19, wherein the series of flags are formed from copper or aluminum.

26. The electrode of claim 19, wherein the electrode is mounted inside of a can comprising a lid.

27. The electrode of claim 26, wherein the series of flags are in electrical communication with the lid of the can.
